(19) United States
(12) Patent Application Publication
(10) Pub. No.: US 2009/0006479 A1
(43) Pub. Date: Jan. 1, 2009

(54) DIGITAL CONTENT PLAYER AND SEMICONDUCTOR INTEGRATED CIRCUIT

(76) Inventors: Hitoshi FUJITA, Osaka (JP); Mitsuya Nakahara, Osaka (JP)

Correspondence Address: MCDERMOTT WILL & EMERY LLP, 600 13TH STREET, NW, WASHINGTON, DC, 20005-3096, US

(21) Appl. No.: 12/147,182

(22) Filed: Jun. 26, 2008

(30) Foreign Application Priority Data
Jun. 29, 2007 (JP) 2007-172306
Jan. 31, 2008 (JP) 2008-021533

(51) Int. Cl. G06F 7/00

(52) U.S. Cl. 707/104.1; 707/E17.009

(57) ABSTRACT

A play unit plays contents based on a playlist. A storage unit stores playlist schedule information which is indicative of a takeover playlist and a playlist switching condition. A monitoring unit monitors the state of play of contents in the play unit. A switching unit determines whether the play state monitored by the monitoring unit fulfills the playlist switching condition indicated by the playlist schedule information. If the playlist switching condition is determined to be fulfilled, the playlist currently assigned to the play unit is switched to the takeover playlist indicated by the playlist schedule information.

### CROSS-REFERENCE TO RELATED APPLICATIONS

This application claims priority under 35 U.S.C. §119(a) on Japanese Patent Application No. 2007-172306 filed on Jun. 29, 2007 and Japanese Patent Application No. 2008-021533 filed on Jan. 31, 2008, the entire contents of which are hereby incorporated by reference.

### BACKGROUND OF THE INVENTION

The present invention relates to a technique for playing contents based on playlists, and more specifically, relates to control over playlist switching.

In recent years, storage media for digital content players increased in variety and capacity, and such storage media became possible to store a huge number of contents. Therefore, conventional methods use a plurality of playlists to manage a large number of contents. In this specification, the term “content” means data to be played by a content player, such as sound data, movie data, still picture data, or the like, and the term “playlist” means information for managing the play order of contents. Conventional devices for controlling the play of contents using a plurality of playlists mainly employ the following two methods:

(1) if, during the play of contents based on a certain playlist, another playlist is selected, the selection result is immediately made effective to switch the playlists;

(2) an editable playlist is prepared, and the data in a newly selected playlist are merged into the editable playlist, whereby the playlist is switched.

In the case of method (1), however, the selection result is immediately made effective even during the play of a content of a playlist, and hence, the play of the content is undesirably interrupted. In the case of method (2), the play of a content is not interrupted, but the playlist need to be reedited to play only the contents of the selected playlist.

In the field of play of DVD data, there is proposed a method of performing a process on an event during the play of a playlist wherein the time of occurrence of the event and the parameters for a process triggered by occurrence of the event are described in a playlist with which data to be played are managed, such that various effects are produced during play of the data (for example, JP 2005-353212 A).

Conventional digital content players, however, have such a disadvantage that, when a playlist is selected during play of contents, the selection result is immediately made effective so that the playlist is switched, and therefore, switching of the playlist cannot be scheduled.

### SUMMARY OF THE INVENTION

A digital content player according to the present invention is a device for playing contents using a plurality of playlists, the digital content player including: a play unit for playing contents based on any one of the plurality of playlists which is assigned to the play unit; a storage unit for storing playlist schedule information which is indicative of a takeover playlist and a playlist switching condition, the takeover playlist being a playlist scheduled to be newly assigned to the play unit, the playlist switching condition being a condition for playlist switching; a monitoring unit for monitoring a state of the play of the contents in the play unit; and a switching unit which determines whether the state of the play monitored by the monitoring unit fulfills the playlist switching condition indicated by the playlist schedule information and which switches, if the switching unit determines that the playlist switching condition is fulfilled, a playlist currently assigned to the play unit to the takeover playlist indicated by the playlist schedule information.

In the digital content player, the playlist switching can be withheld till the playlist switching condition is fulfilled. The playlist switching thus can be scheduled.

### BRIEF DESCRIPTION OF THE DRAWINGS

FIG. 1 is a block diagram showing the configuration of a digital content player according to the first embodiment of the present invention.

FIG. 2 is a flowchart for illustrating the operations of the digital content player shown in FIG. 1.

FIG. 3 is a block diagram showing a modification of the digital content player shown in FIG. 1.

FIG. 4 is a flowchart for illustrating the operations of the digital content player shown in FIG. 3.

FIG. 5 is a block diagram showing another modification of the digital content player shown in FIG. 1.

FIG. 6 is a flowchart for illustrating the operations of the digital content player shown in FIG. 5.

FIG. 7 is a block diagram showing the configuration of a digital content player according to the second embodiment of the present invention.

FIG. 8 is a flowchart for illustrating the operations of the digital content player shown in FIG. 7.

FIG. 9 is a block diagram showing a configuration of a digital content player according to the third embodiment of the present invention.

FIG. 10 is a flowchart for illustrating the operations of the digital content player shown in FIG. 9.

FIG. 11 is a block diagram showing the configuration of a digital content player according to the fourth embodiment of the present invention.

FIG. 12 is a flowchart for illustrating the operations of the digital content player shown in FIG. 11.

FIG. 13 is a block diagram showing the configuration of a digital content player according to the fifth embodiment of the present invention.

FIG. 14 is a flowchart for illustrating the operations of the digital content player shown in FIG. 13.

FIG. 15 shows playlist schedule information sets chained in the order of storage.

FIG. 16 is a flowchart for illustrating the operations of the digital content player shown in FIG. 15.

FIG. 17 is a block diagram showing the configuration of a digital content player according to the sixth embodiment of the present invention.

FIG. 18 is a flowchart for illustrating the operations of the digital content player shown in FIG. 17.

FIG. 19 illustrates how to delete a set of playlist schedule information.

FIG. 20 is a block diagram showing the configuration of a digital content player according to the seventh embodiment of the present invention.

FIG. 21 is a flowchart for illustrating the operations of the digital content player shown in FIG. 20.

FIG. 22 is a block diagram showing the configuration of a digital content player according to the eighth embodiment of the present invention.

FIG. 23 is a flowchart for illustrating the operations of the digital content player shown in FIG. 22.

### DESCRIPTION OF THE PREFERRED EMBODIMENTS

Hereinafter, embodiments of the present invention are described in detail with reference to the accompanying drawings. Identical or equivalent elements in the drawings are denoted by identical reference numerals to avoid repetitive description.

### First Embodiment

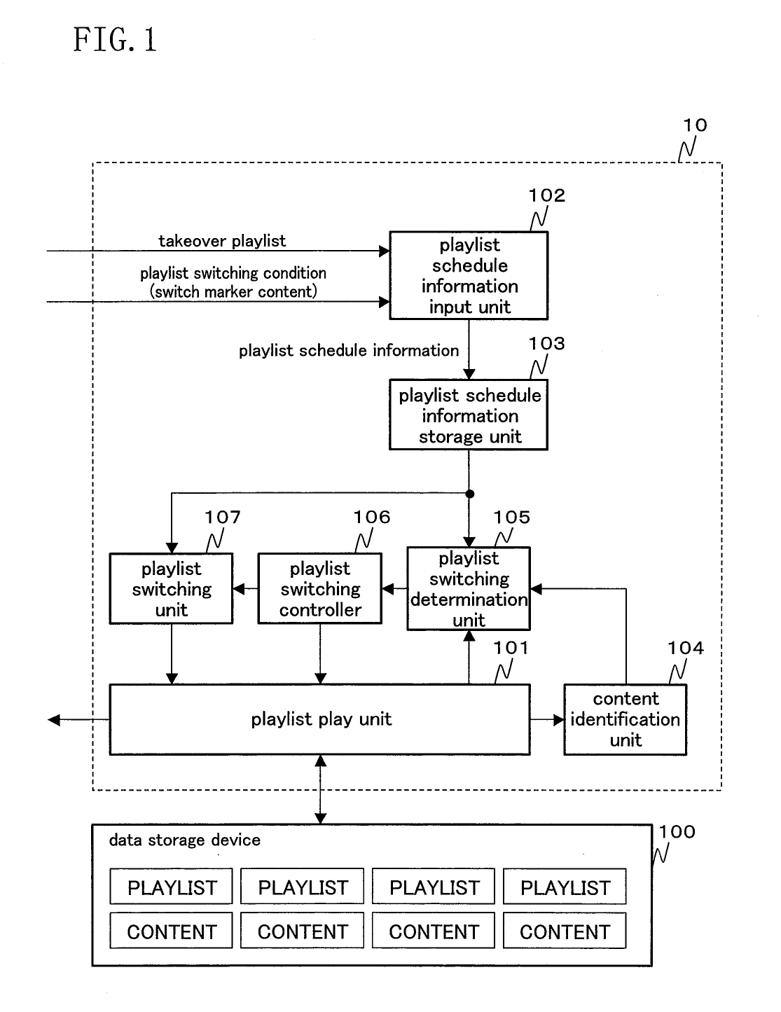

FIG. 1 shows the configuration of a digital content player 10 according to the first embodiment of the present invention. The digital content player 10 plays contents stored in a data storage device 100 according to playlists stored in the data storage device 100. Each playlist shows a group of contents to be played and the play order of the contents. In the digital content player 10, a playlist that is to be newly assigned to the playlist play unit 101 (takeover playlist) and a condition for switching a playlist currently assigned to a playlist play unit 101 to the takeover playlist (playlist switching condition) are designated by user operation. In the example described herein, a content on the border between the current playlist and the takeover playlist, i.e., a content which serves as a marker indicative of the point at which the current playlist is switched to the takeover playlist (switch marker content) is designated as the playlist switching condition.

The digital content player 10 includes the playlist play unit 101, a playlist schedule information input unit 102, a playlist schedule information storage unit 103, a content identification unit 104, a playlist switching determination unit 105, a playlist switching controller 106, and a playlist switching unit 107.

Any one of the plurality of playlists stored in the data storage device 100 is assigned to the playlist play unit 101, and the playlist play unit 101 plays the contents stored in the data storage device 100 based on the assigned playlist.

The playlist schedule information input unit 102 prepares a set of information indicative of the takeover playlist and information indicative of the playlist switching condition (in this example, the switch marker content), which are designated by user operation, and stores the set of information as playlist schedule information in the playlist schedule information storage unit 103.

The content identification unit 104 identifies a content currently being played by the playlist play unit 101 and notifies the playlist switching determination unit 105 about the identification result.

The playlist switching determination unit 105 receives the identification result from the content identification unit 104 and monitors whether the playlist play unit 101 has finished playing the content. If detecting that the playlist play unit 101 has finished playing the content, the playlist switching determination unit 105 determines whether the finished content matches the content indicated by the playlist schedule information stored in the playlist schedule information storage unit 103. If determining that the finished content matches the content indicated by the playlist schedule information, the playlist switching determination unit 105 issues a switching request to the playlist switching controller 106. That is, when detecting that the playlist play unit 101 has finished playing the content indicated by the playlist schedule information, the playlist switching determination unit 105 issues a switching request.

According to the switching request from the playlist switching determination unit 105, the playlist switching controller 106 issues a switching instruction to the playlist switching unit 107. The playlist switching controller 106 also stops the playlist play unit 101 from playing contents.

According to the switching instruction from the playlist switching controller 106, the playlist switching unit 107 switches the playlist currently assigned to the playlist play unit 101 to the takeover playlist indicated by the playlist schedule information stored in the playlist schedule information storage unit 103.

Upon completion of the playlist switching by the playlist switching unit 107, the playlist switching controller 106 instructs the playlist play unit 101 to start playing the contents.

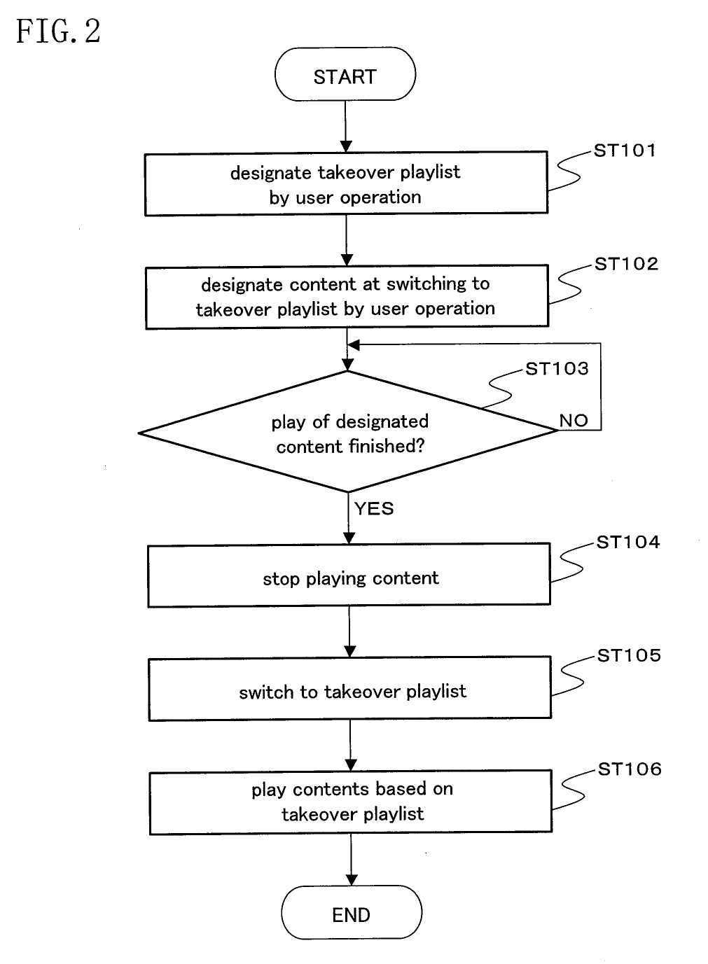

The operations of the digital content player shown in FIG. 1 are now described with reference to FIG. 2.

First, a takeover playlist is designated by user operation (step ST101), and a content indicative of the point at which the current playlist is switched to the takeover playlist (switch marker content) is designated by user operation (step ST102). Playlist schedule information indicative of the takeover playlist and the switch marker content is accordingly stored in the playlist schedule information storage unit 103. Step ST102 may be executed prior to step ST101.

Then, when the playlist play unit 101 has finished playing the switch marker content indicated by the playlist schedule information (the content designated in step ST102), the playlist switching determination unit 105 issues a switching request to the playlist switching controller 106 (step ST103). Then, the playlist switching controller 106 stops the playlist play unit 101 from playing the contents of the current playlist (step ST104), and the playlist switching unit 107 switches the playlists (step ST105). Upon completion of the playlist switching, the playlist switching controller 106 instructs the playlist play unit 101 to start playing contents (step ST106). The playlist play unit 101 thus starts playing the contents based on the newly assigned playlist.

As described above, the playlist switching can be withheld till the play of a designated content is finished. The playlist switching thus can be scheduled without immediately stopping the play of the content.

As for movie contents, the present embodiment can be realized in such a form that the end of a scene and/or a chapter is detected in combination with scene information and/or chapter information in a movie content to schedule the play of contents so as to be switched to the next content, scene, or chapter.

As for still picture contents, the playlist play unit 101 may be realized as a block presenting pictures included in a given playlist in the form of a slide show according to the playlist. The timing of switching the pictures may be designated by a user or may depend on passage of a predetermined time.

First Modification of First Embodiment

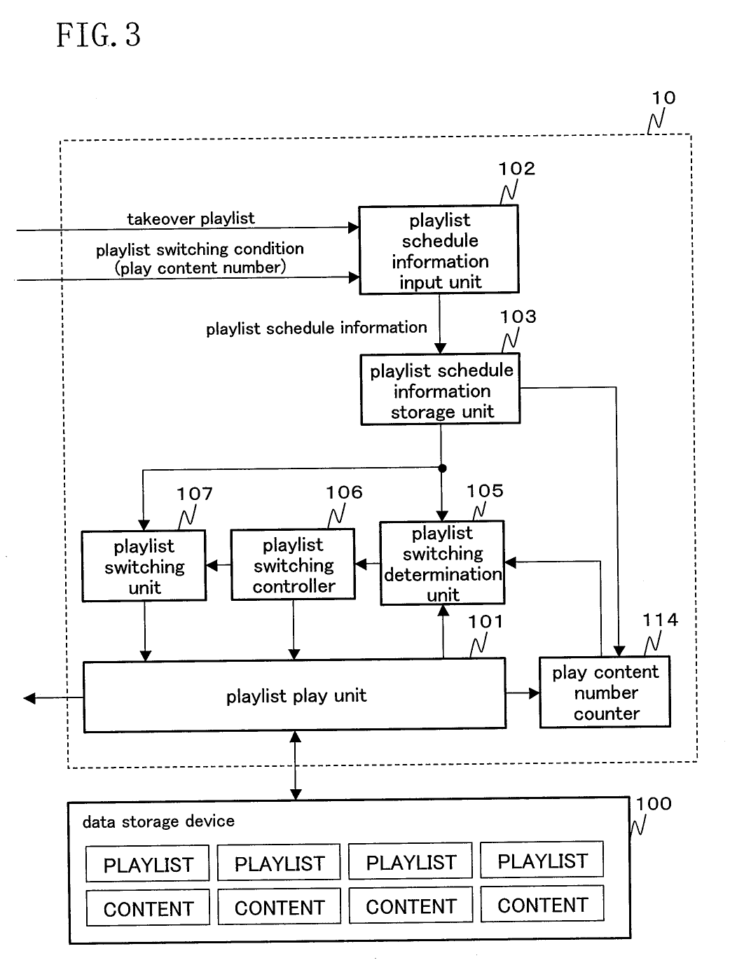

The digital content player 10 may include, as shown in FIG. 3, a play content number counter 114 instead of the content identification unit 104 of FIG. 1. In this example, the number of contents to be played before switching the current playlist to a takeover playlist (play content number) is designated as a playlist switching condition.

The playlist schedule information input unit 102 prepares a set of information indicative of the takeover playlist and information indicative of the number of contents to be played, which are designated by user operation, and stores the set of information as playlist schedule information in the playlist schedule information storage unit 103.

The play content number counter 114 counts the number of contents played since the playlist schedule information is stored in the playlist schedule information storage unit 103 to notify the playlist switching determination unit 105 about the counting result.

The playlist switching determination unit 105 determines whether the number of contents counted by the play content number counter 114 reaches the play content number indicated by the playlist schedule information stored in the playlist schedule information storage unit 103. If the play content number is reached, the playlist switching determination unit 105 issues a switching instruction to the playlist switching controller 106 at the end of the play of a current content.

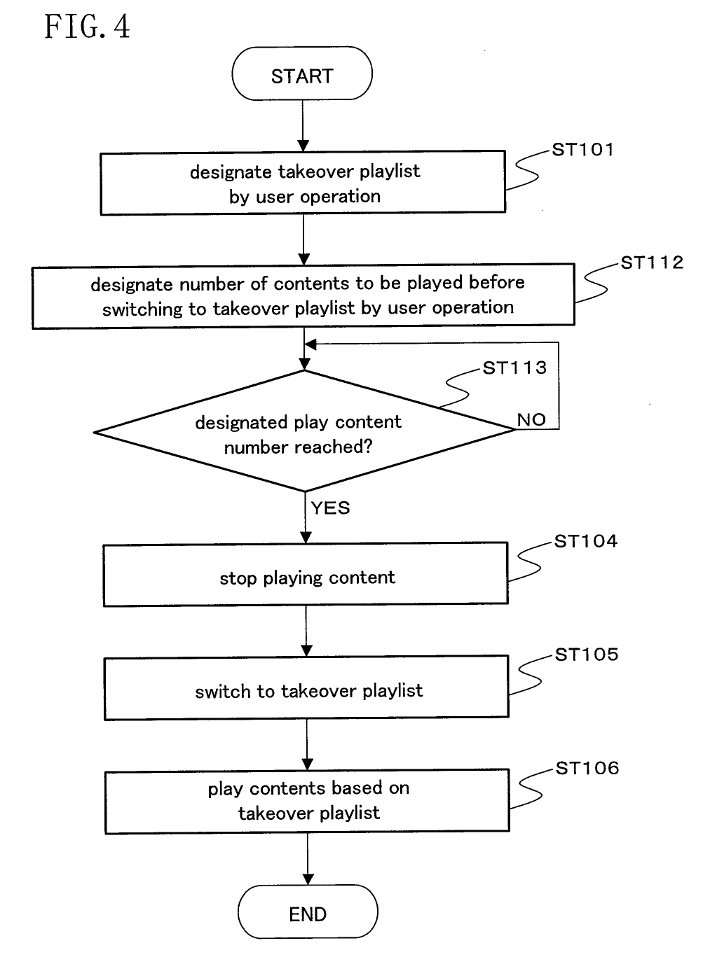

The operations of the digital content player 10 shown in FIG. 3 are now described with reference to FIG. 4. In this example, steps ST112 and ST113 are executed instead of steps ST102 and ST103 of FIG. 2.

First, the takeover playlist is designated by user operation (step ST101), and the number of contents to be played before switching the current playlist to the takeover playlist (play content number) is designated by user operation (step ST112). Playlist schedule information indicative of the takeover playlist and the play content number is accordingly stored in the playlist schedule information storage unit 103. Step ST112 may be executed prior to step ST101.

Then, if the number of contents played by the playlist play unit 101 since the playlist schedule information is stored in the playlist schedule information storage unit 103 reaches the play content number indicated by the playlist schedule information, the playlist switching determination unit 105 issues a switching request to the playlist switching controller 106 (step ST113). Then, the processes of steps ST104, ST105, and ST106 are performed.

As described above, the playlist switching can be withheld till the play of a predesignated number of contents is finished. The playlist switching thus can be scheduled.

Second Modification of First Embodiment

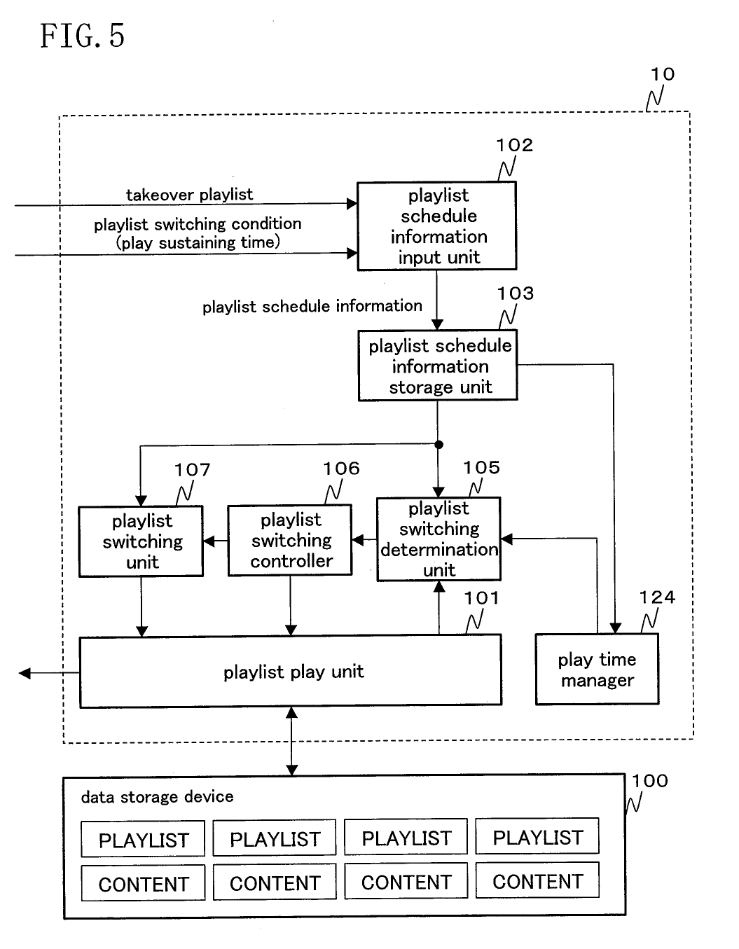

The digital content player 10 may include, as shown in FIG. 5, a play time manager 124 instead of the content identification unit 104 of FIG. 1. In this example, the play time length sustained before the current playlist is switched to a takeover playlist (play sustaining time) is designated as a playlist switching condition.

The playlist schedule information input unit 102 prepares a set of information indicative of the takeover playlist and information indicative of the play sustaining time, which are designated by user operation, and stores the set of information as playlist schedule information in the playlist schedule information storage unit 103.

The play time manager 124 measures the time passed since the playlist schedule information is stored in the playlist schedule information storage unit 103 to notify the playlist switching determination unit 105 about the measurement result.

The playlist switching determination unit 105 determines whether the time measured by the play time manager 124 reaches the play sustaining time indicated by the playlist schedule information stored in the playlist schedule information storage unit 103. If the play sustaining time is reached, the playlist switching determination unit 105 issues a switching request to the playlist switching controller 106.

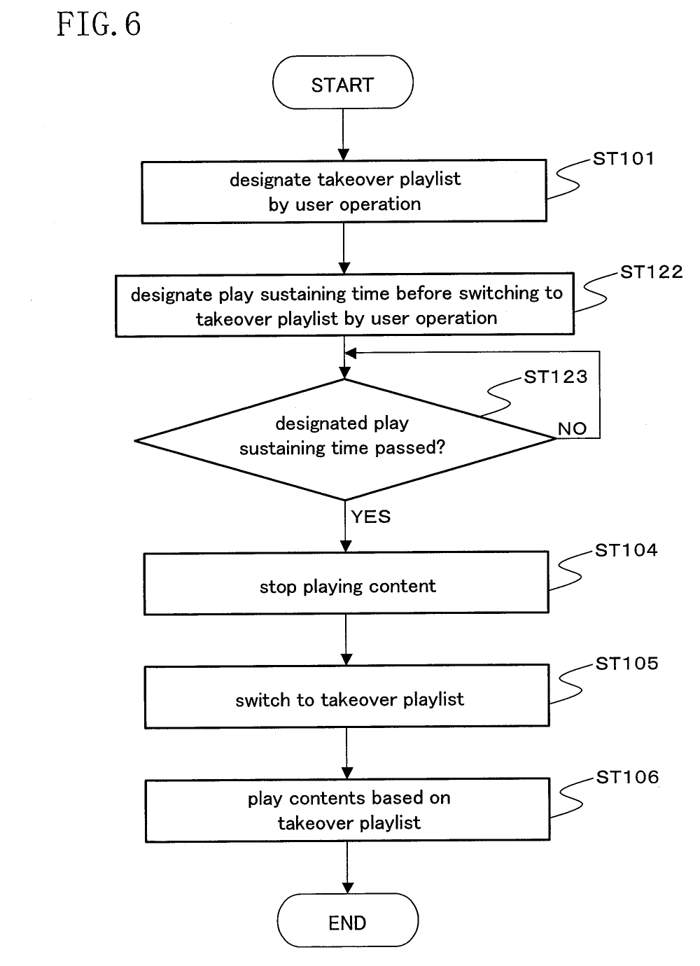

The operations of the digital content player 10 shown in FIG. 5 are now described with reference to FIG. 6. In this example, steps ST122 and ST123 are executed instead of steps ST102 and ST103 of FIG. 2.

First, the takeover playlist is designated by user operation (step ST101), and the play time length sustained before the current playlist is switched to a takeover playlist (play sustaining time) is designated by user operation (step ST122). Playlist schedule information indicative of the takeover playlist and the play sustaining time is accordingly stored in the playlist schedule information storage unit 103. Step ST122 may be executed prior to step ST101.

Then, if the time passed since the playlist schedule information is stored in the playlist schedule information storage unit 103 reaches the play sustaining time indicated by the playlist schedule information, the playlist switching determination unit 105 issues a switching request to the playlist switching controller 106 (step ST123). Then, the processes of steps ST104, ST105, and ST106 are performed.

As described above, the playlist switching can be withheld till the predesignated play sustaining time passes. The playlist switching thus can be scheduled.

### Second Embodiment

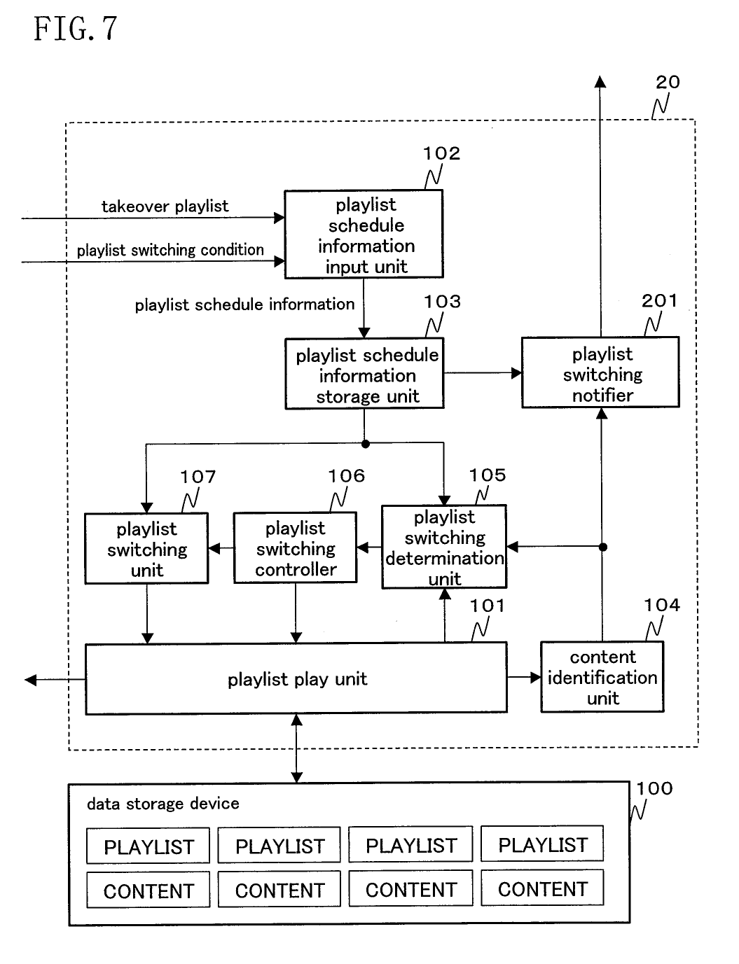

FIG. 7 shows the configuration of a digital content player 20 according to the second embodiment of the present invention. The digital content player 20 includes a playlist switching notifier 201 in addition to the components shown in FIG. 1. The playlist switching notifier 201 receives the identification result from the content identification unit 104 to obtain the information about a content currently being played. If the content currently being played matches the content indicated by the playlist schedule information stored in the playlist schedule information storage unit 103, the playlist switching notifier 201 notifies the outside, e.g., a user, about a schedule of switching the playlists at the end of the play of the currently played content.

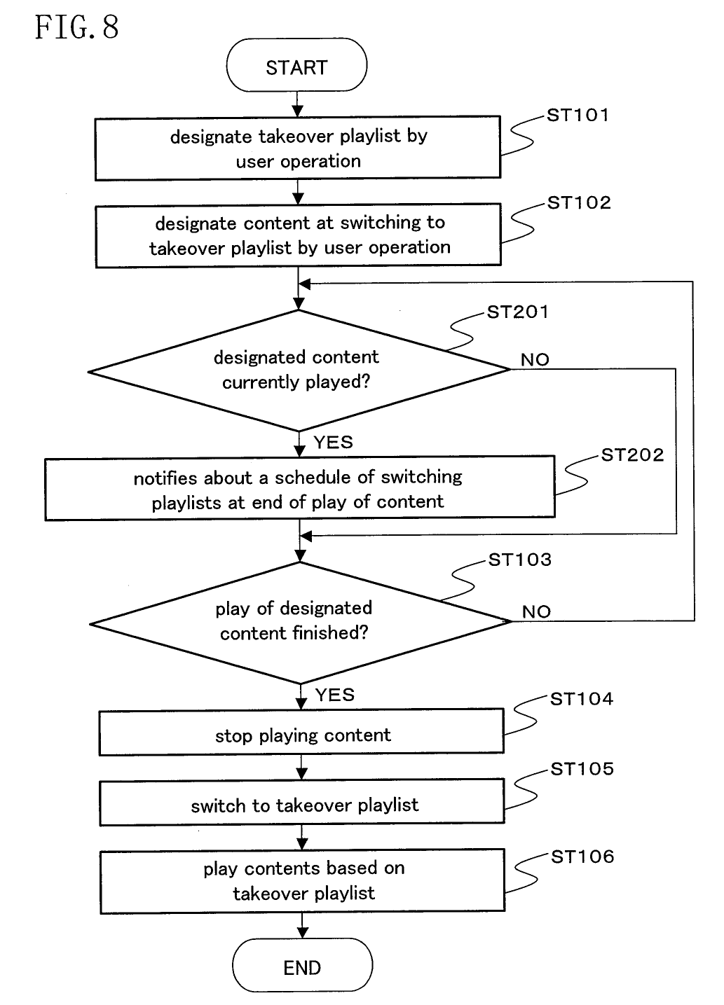

The operations of the digital content player 20 shown in FIG. 7 are now described with reference to FIG. 8. In this example, steps ST201 and ST202 are executed in addition to the processes shown in FIG. 2.

First, the takeover playlist and the playlist switching condition are designated by user operation (steps ST101 and ST102). Then, the playlist switching notifier 201 determines whether the switch marker content indicated by the playlist schedule information stored in the playlist schedule information storage unit 103 (the content designated in step ST102) is currently being played by the playlist play unit 101 based on the identification result from the content identification unit 104 (step ST201). If the switch marker content is currently being played, the playlist switching notifier 201 notifies the outside, e.g., a user, about a schedule of switching the playlists at the end of the play of the currently played content (step ST202). Then, the processes of steps ST103 to ST106 are performed.

As described above, this embodiment enables to notify a user that the current content is the last content in the current playlist before switching to the takeover playlist as well as to schedule playlist switching.

It should be noted that the playlist switching notifier 201 is also applicable to the digital content player 10 shown in FIG. 3. In this case, the playlist switching notifier 201 notifies the outside, e.g., a user, about the number of remaining contents, which is calculated by subtracting the number of contents counted by the play content number counter 114 from the play content number indicated by the playlist schedule information stored in the playlist schedule information storage unit 103. This configuration enables to notify a user about the number of contents remaining before the playlist switching.

The playlist switching notifier 201 is also applicable to the digital content player 10 shown in FIG. 5. In this case, the playlist switching notifier 201 receives the measurement result from the play time manager 124 to obtain the information about the passed time and notifies the outside, e.g., a user, about the remaining time length calculated by subtracting the passed time from the play sustaining time indicated by the playlist schedule information stored in the playlist schedule information storage unit 103. This configuration enables to notify a user about the time length remaining before the playlist switching.

### Third Embodiment

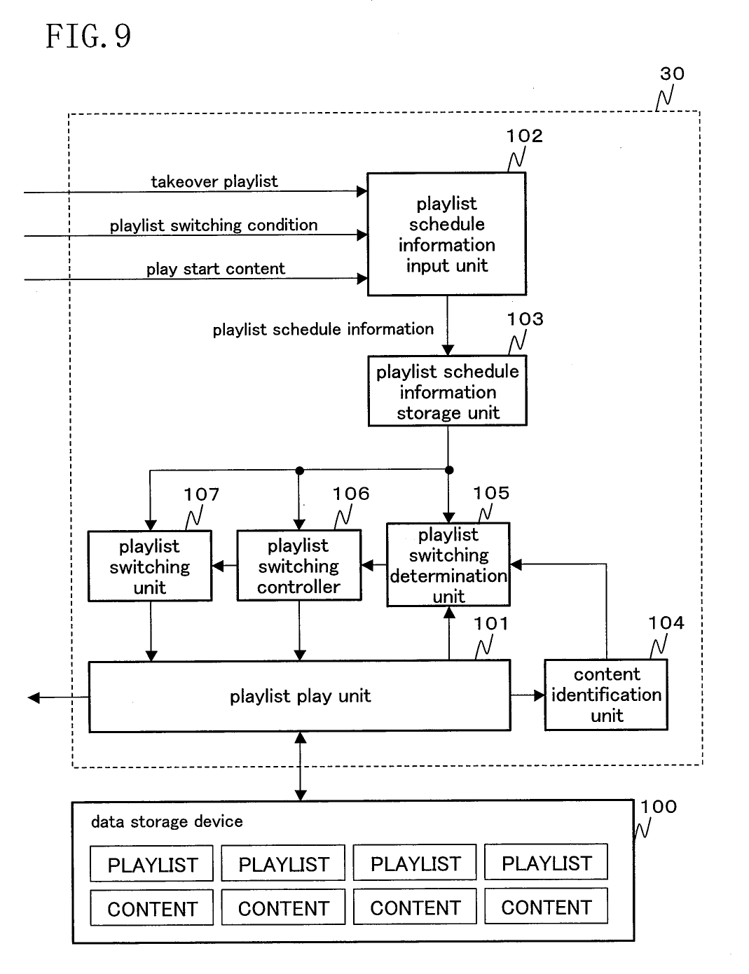

FIG. 9 shows the configuration of a digital content player 30 according to the third embodiment of the present invention. Although the digital content player 30 has a configuration basically equal to that shown in FIG. 1, a content of the takeover playlist which is to be played first after the playlist switching (play start content) is designated by user operation.

The playlist schedule information input unit 102 prepares a set of information indicative of the takeover playlist, information indicative of the playlist switching condition, and information indicative of the play start content, which are designated by user operation, and stores the set of information as playlist schedule information in the playlist schedule information storage unit 103.

The playlist switching controller 106 controls the playlist play unit 101 such that, upon completion of the playlist switching by the playlist switching unit 107, the play is started with the play start content indicated by the playlist schedule information stored in the playlist schedule information storage unit 103.

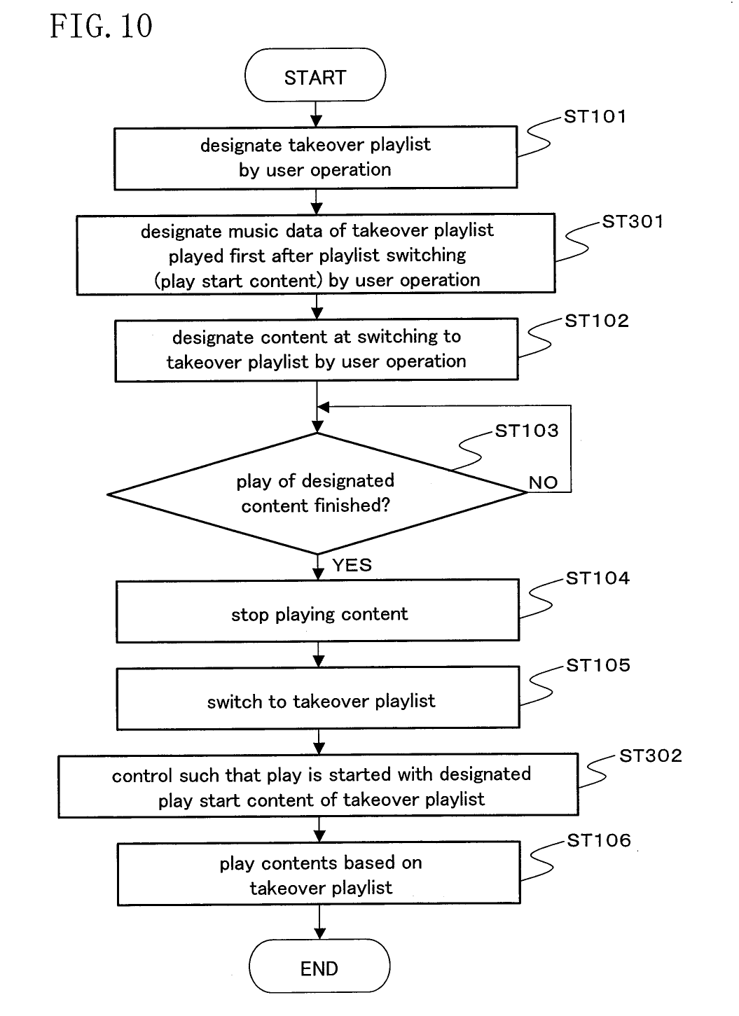

The operations of the digital content player 30 shown in FIG. 9 are now described with reference to FIG. 10. In this embodiment, steps ST301 and ST302 are executed in addition to the processes shown in FIG. 2.

First, the takeover playlist is designated by user operation (step ST101), a content of the takeover playlist which is to be played first after the playlist switching (play start content) is designated by user operation (step ST301), and the playlist switching condition is designated by user operation (step ST102). Playlist schedule information indicative of the takeover playlist, the playlist switching condition, and the play start content is accordingly stored in the playlist schedule information storage unit 103. The order of executing steps ST101, ST301, and ST102 is not limited to this but, for example, step ST102 may be executed prior to step ST101.

Then, the processes of steps ST103, ST104, and ST105 are performed so that the playlist switching unit 107 switches the playlists. Then, the playlist switching controller 106 controls the playlist play unit 101 such that the play is started with the play start content indicated by the playlist schedule information, i.e., the content designated in step ST301 (step ST302). The playlist play unit 101 then sequentially plays the contents shown in the newly assigned playlist from the play start content (step ST106).

As described above, this embodiment enables to designate the play start content of the takeover playlist as well as to schedule playlist switching.

As well as the play start content, a content of the takeover playlist with which the play of the takeover playlist is ended (play end content) also may be designated. In this case, the playlist schedule information storage unit 103 stores playlist schedule information which includes the play end content in addition to the takeover playlist, the playlist switching condition, and the play start content. The playlist switching controller 106 identifies a content currently being played. If the content currently being played matches the play end content indicated by the playlist schedule information, the playlist switching controller 106 stops the playlist play unit 101 from playing contents at the end of the play of the currently played content. This configuration enables to designate the play end content of the takeover playlist. Designating the play start content and the play end content enables to designate which part of the takeover playlist is to be played.

Each of the digital content players shown in FIG. 3, FIG. 5 and FIG. 7 may be configured such that the play start content and/or the play end content is designated by user operation.

### Fourth Embodiment

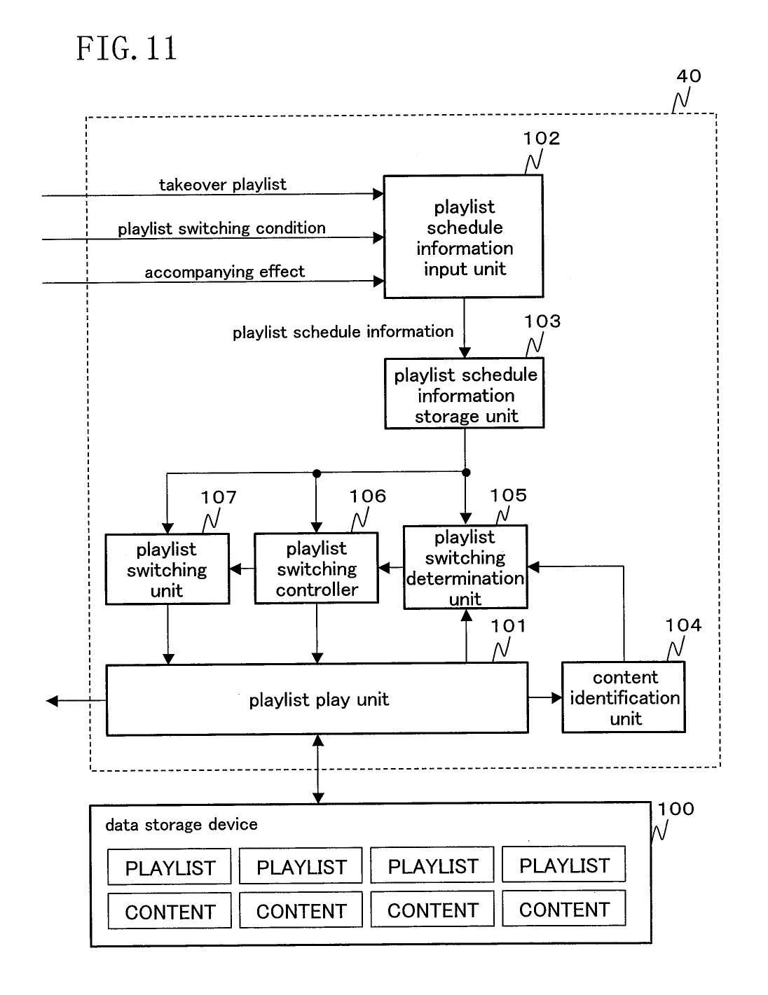

FIG. 11 shows the configuration of a digital content player 40 according to the fourth embodiment of the present invention. Although the digital content player 40 has a configuration basically equal to that shown in FIG. 1, an accompanying effect which is to be executed during the play of contents based on the takeover playlist is also designated by user operation. In this specification, examples of the accompanying effect include bass boost effect, stereo/monaural conversion, and surround-sound effect for audio contents, and contrast control, color saturation control, and filtering effect for movie and still picture contents.

The playlist schedule information input unit 102 prepares a set of information indicative of the takeover playlist, information indicative of the playlist switching condition, and information indicative of the accompanying effect, which are designated by user operation, and stores the set of information as playlist schedule information in the playlist schedule information storage unit 103.

The playlist switching controller 106 controls the playlist play unit 101 such that the accompanying effect indicated by the playlist schedule information stored in the playlist schedule information storage unit 103 is executed after completion of the playlist switching by the playlist switching unit 107.

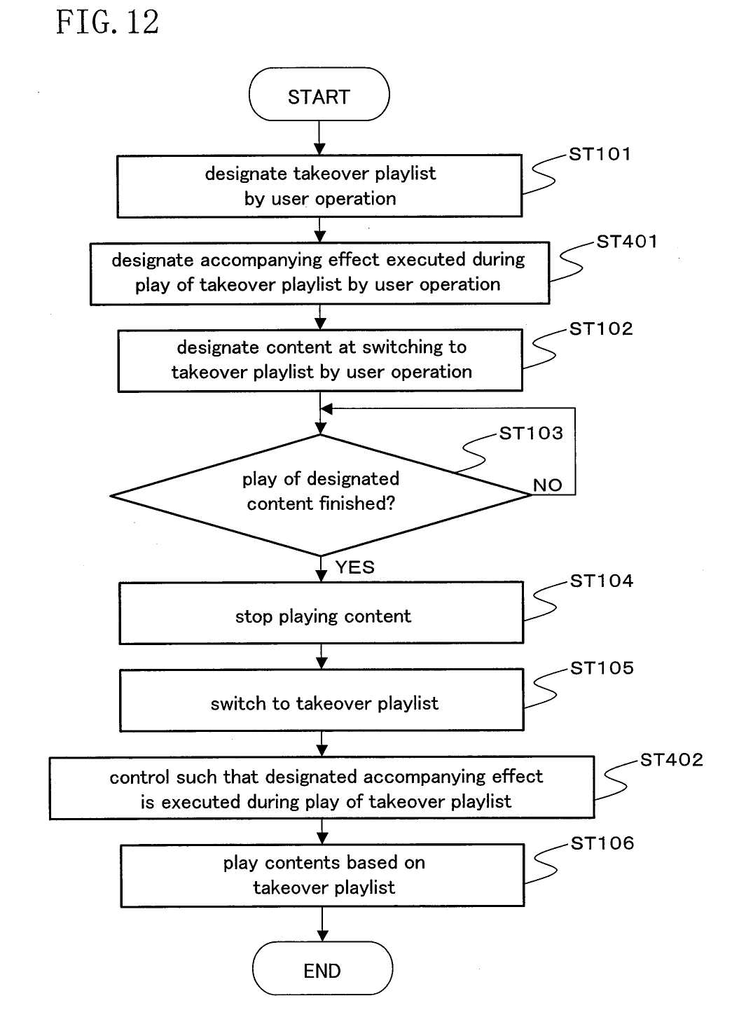

The operations of the digital content player 40 shown in FIG. 11 are now described with reference to FIG. 12. In this embodiment, steps ST401 and ST402 are executed in addition to the processes shown in FIG. 2.

First, the takeover playlist is designated by user operation (step ST101), the accompanying effect which is to be executed during the play of the takeover playlist is designated by user operation (step ST401), and the playlist switching condition is designated by user operation (step ST102). The playlist schedule information indicative of the takeover playlist, the playlist switching condition, and the accompanying effect is accordingly stored in the playlist schedule information storage unit 103. The order of executing steps ST101, ST401, and ST102 is not limited to this but, for example, step ST102 may be executed prior to step ST101.

Then, the processes of steps ST103, ST104, and ST105 are performed so that the playlist switching unit 107 switches the playlists. Then, the playlist switching controller 106 controls the playlist play unit 101 so as to execute the accompanying effect indicated by the playlist schedule information, i.e., the accompanying effect designated by user operation (step ST402). Then, the playlist play unit 101 starts playing contents based on the newly assigned playlist and executes the accompanying effect designated by user operation (step ST106).

As described above, this embodiment enables to designate the accompanying effect of the takeover playlist as well as to schedule playlist switching.

Each of the digital content players shown in FIG. 3, FIG. 5, FIG. 7 and FIG. 9 may be configured such that the accompanying effect is designated by user operation.

### Fifth Embodiment

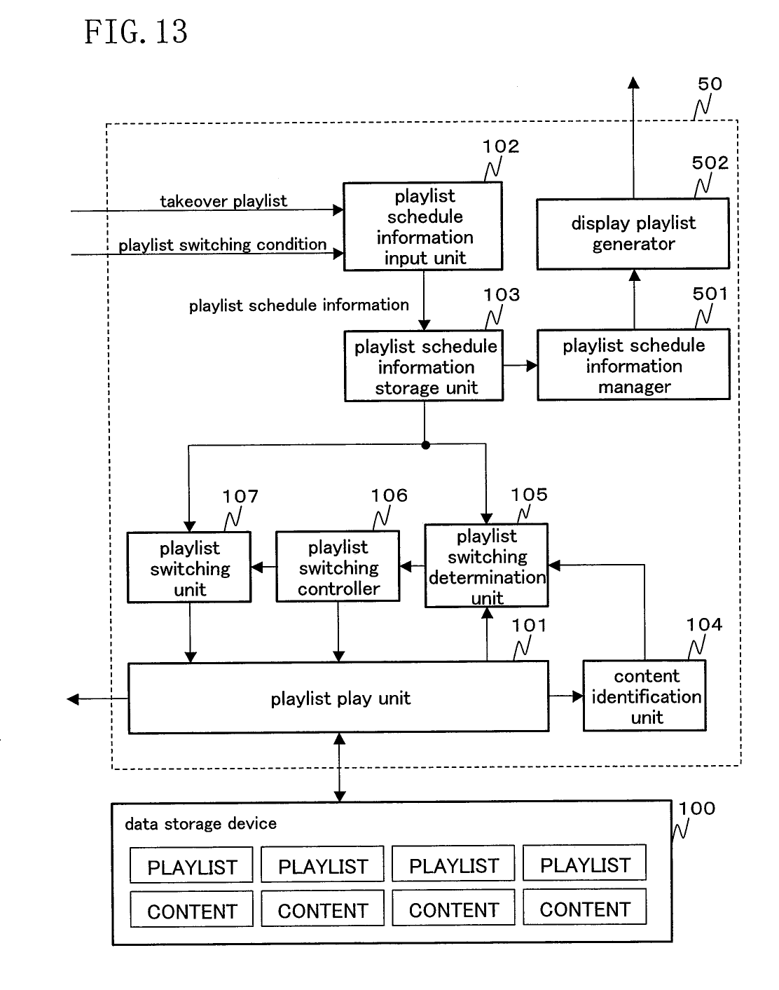

FIG. 13 shows the configuration of a digital content player according to the fifth embodiment of the present invention. The digital content player 50 includes a playlist schedule information manager 501 and a display playlist generator 502 in addition to the components shown in FIG. 1.

The playlist schedule information manager 501 manages the storage state of the playlist schedule information in the playlist schedule information storage unit 103 such that a plurality of sets of playlist schedule information are chained in the order of storage.

The display playlist generator 502 obtains the information about the playlist schedule information stored in the playlist schedule information storage unit 103 and the chain order of the playlist schedule information sets based on the management result from the playlist schedule information manager 501 to generate a playlist for display which shows upcoming contents scheduled to be played.

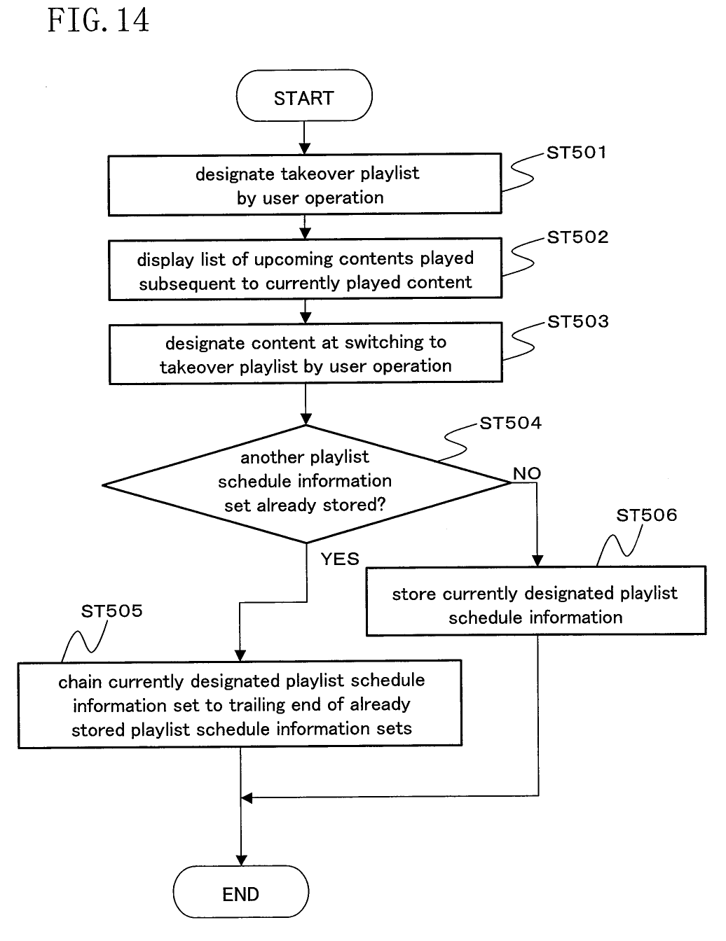

The process of storing the playlist schedule information in the digital content player 50 shown in FIG. 13 is now described with reference to FIG. 14.

First, the takeover playlist is designated by user operation (step ST501). Then, the display playlist generator 502 generates a playlist for display which shows upcoming contents scheduled to be played based on the management result of the playlist schedule information manager 501 (step ST502). The playlist for display is supplied to the outside, e.g., a user, and the user can refer to the displayed playlist to designate a content indicative of the point at which the current playlist is switched to the takeover playlist (switch marker content). Then, the playlist switching condition (in this example, the switch marker content) is designated by user operation (step ST503). The new playlist schedule information set is accordingly stored in the playlist schedule information storage unit 103.

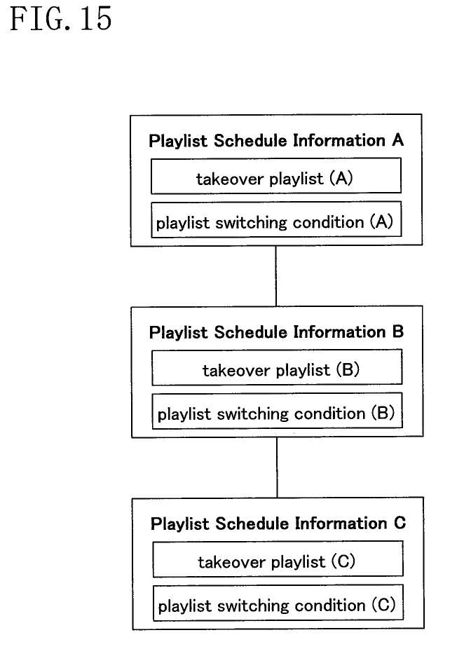

Then, the playlist schedule information manager 501 determines whether any other set of playlist schedule information is already stored in the playlist schedule information storage unit 103 (step ST504). If any other playlist schedule information set is already stored there, the playlist schedule information manager 501 chains the newly stored playlist schedule information set to the trailing end of the already stored playlist schedule information sets (step ST505). If any playlist schedule information is not yet stored in the playlist schedule information storage unit 103, the playlist schedule information manager 501 does not modify the storage state of the newly stored playlist schedule information (step ST506). As a result, a plurality of sets of playlist schedule information chained in the order of storage as shown in FIG. 15 are held in the playlist schedule information storage unit 103.

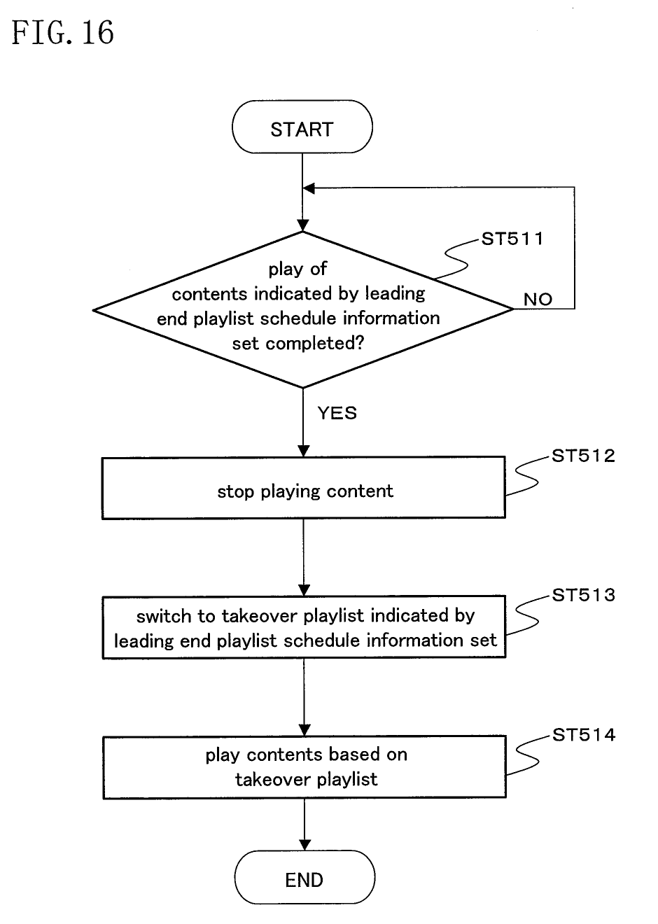

The process of switching playlist in the digital content player 50 shown in FIG. 13 is now described with reference to FIG. 16.

The playlist switching determination unit 105 refers to the leading end set of the playlist schedule information stored in the playlist schedule information storage unit 103. When detecting completion of the play of the contents indicated by the leading end playlist schedule information set, the playlist switching determination unit 105 issues a switching request to the playlist switching controller 106 (step ST511). Then, the playlist switching controller 106 stops the playlist play unit 101 from playing the contents (step ST512). The playlist switching unit 107 then refers to the leading end set of the playlist schedule information stored in the playlist schedule information storage unit 103 to switch the playlist currently assigned to the playlist play unit 101 to the takeover playlist indicated by the leading end playlist schedule information set (step ST513). The playlist switching controller 106 then instructs the playlist play unit 101 to start playing the contents (step ST514).

As described above, the playlist schedule information are managed in the form of a chain list, whereby switching of playlist can be sequentially scheduled, and hence, switching of playlist can be sequentially executed.

It should be noted that the playlist schedule information manager 501 and the display playlist generator 502 are also applicable to each of the digital content players shown in FIG. 3, FIG. 5, FIG. 7, FIG. 9 and FIG. 11.

### Sixth Embodiment

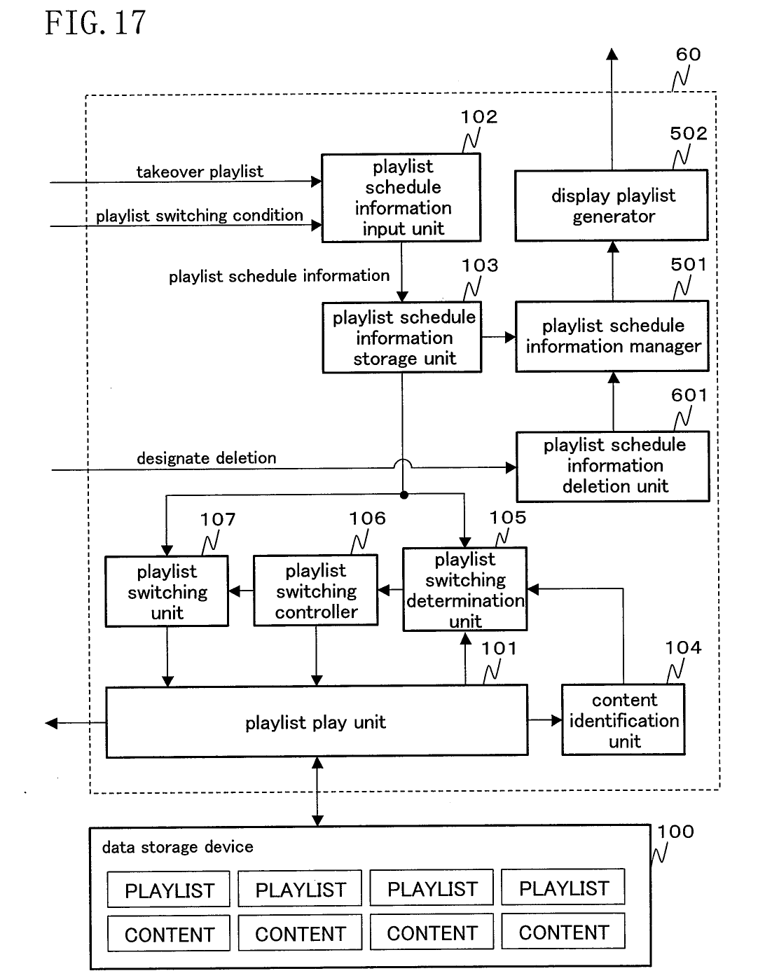

FIG. 17 shows the configuration of a digital content player according to the sixth embodiment of the present invention. The digital content player 60 includes a playlist schedule information deletion unit 601 in addition to the components shown in FIG. 13.

The playlist schedule information deletion unit 601 deletes a set of playlist schedule information designated by user operation from the playlist schedule information storage unit 103 and updates the storage state of the playlist schedule information in the playlist schedule information storage unit 103.

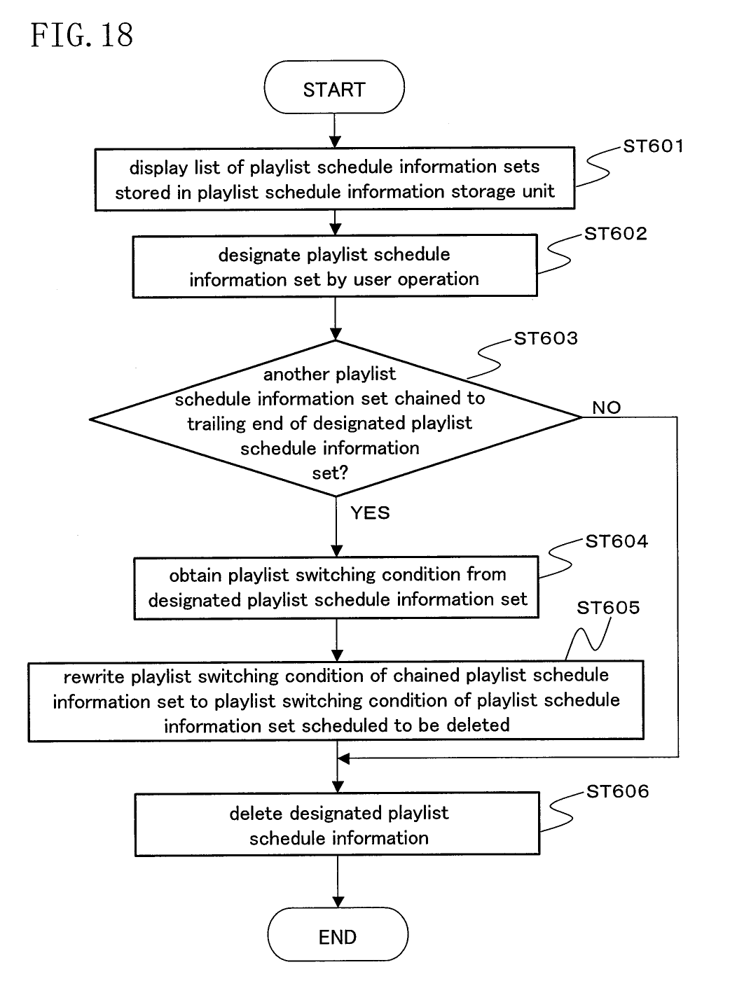

The playlist deletion process by the digital content player 60 shown in FIG. 17 is now described with reference to FIG. 18.

First, the display playlist generator 502 generates a schedule information listing that shows the playlist schedule information sets stored in the playlist schedule information storage unit 103 based on the management result of the playlist schedule information manager 501 and supplies the schedule information listing to the outside, e.g., a user (step ST601). Then, a set of playlist schedule information which is to be deleted from the schedule information listing is designated by user operation (step ST602). Then, the playlist schedule information deletion unit 601 refers to the management result of the playlist schedule information manager 501 to determine whether there is any other set of playlist schedule information chained to the trailing end of the playlist schedule information set designated by user operation (step ST603). If there is any other playlist schedule information set chained, the playlist schedule information deletion unit 601 obtains the playlist switching condition from the playlist schedule information set designated by user operation, i.e., the playlist schedule information set to be deleted (step ST604) and rewrites the playlist switching condition of the another playlist schedule information set chained to the trailing end of the playlist schedule information set scheduled to be deleted to the playlist switching condition of the playlist schedule information set scheduled to be deleted (step ST605). The playlist schedule information deletion unit 601 then deletes the playlist schedule information set scheduled to be deleted, and the playlist schedule information manager 501 updates the chain relationship of the playlist schedule information sets (step ST606).

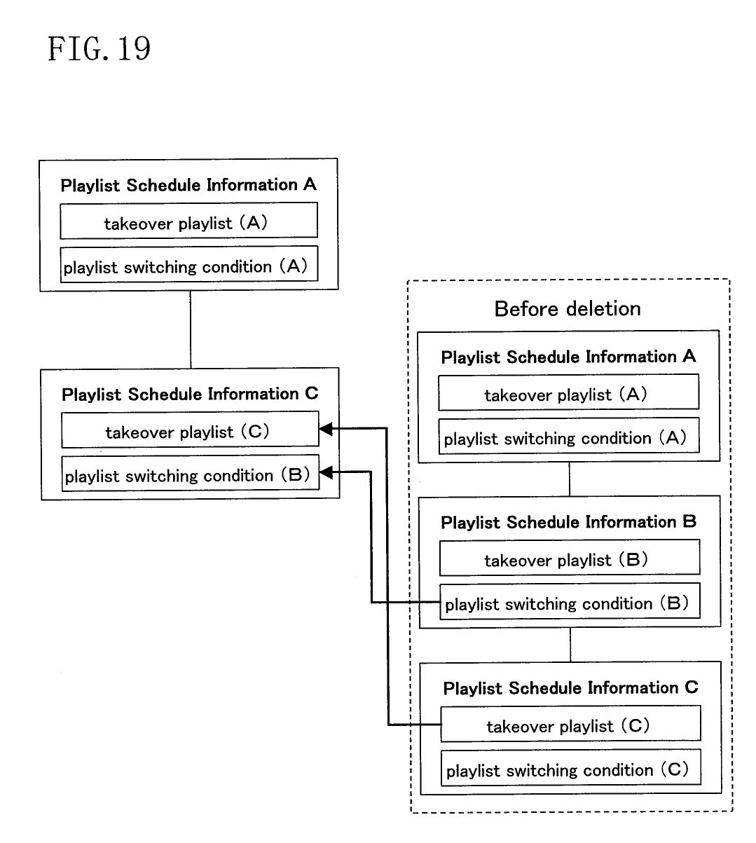

Thus, as shown in FIG. 19, a designated set of playlist schedule information (Playlist Schedule Information B) is deleted, and a set of playlist schedule information originally chained to the trailing end of the deleted playlist schedule information set (Playlist Schedule Information C) is updated. As described above, this embodiment enables to delete an already-scheduled playlist schedule information set.

### Seventh Embodiment

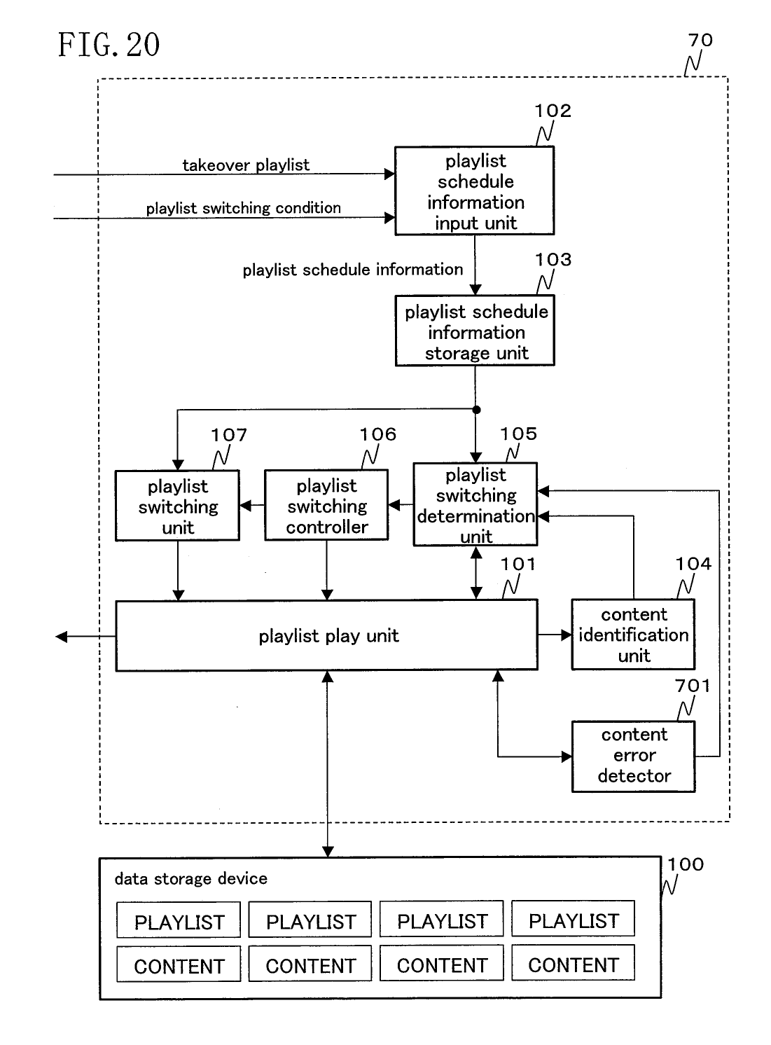

FIG. 20 shows the configuration of a digital content player according to the seventh embodiment of the present invention. The digital content player 70 includes a content error detector 701 in addition to the components shown in FIG. 1.

The content error detector 701 detects errors occurring in the playlist play unit 101. Specifically, when the number of errors occurring during the play of a content in the playlist play unit 101 exceeds a predetermined number, the content error detector 701 determines that the playlist play unit 101 is in a play error state to issue a play stop request to the playlist switching determination unit 105.

According to the play stop request from the content error detector 701, the playlist switching determination unit 105 forcibly stops the playlist play unit 101 from playing the content.

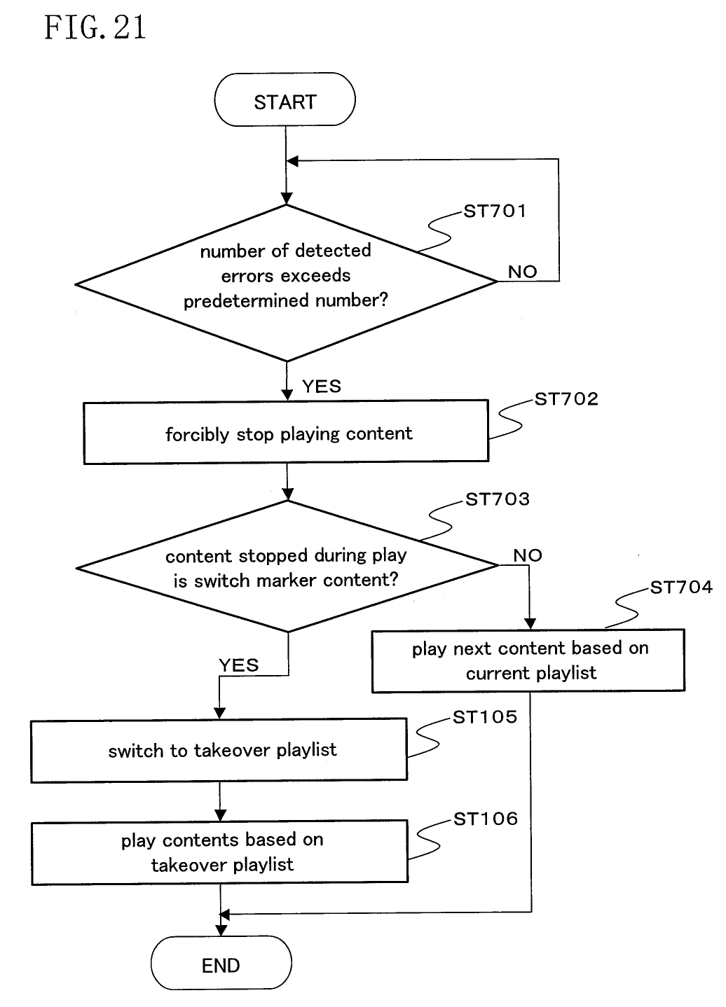

The error detection process in the digital content player 70 shown in FIG. 20 is now described with reference to FIG. 21.

First, when the number of detected errors for a currently played content exceeds a predetermined number, the content error detector 701 issues a play stop request (step ST701). According to the play stop request, the playlist switching determination unit 105 forcibly stops the playlist play unit 101 from playing the content (step ST702).

Then, the playlist switching determination unit 105 determines whether the content stopped during play matches the content indicated by the playlist schedule information (switch marker content) based on the identification result from the content identification unit 104 (step ST703).

If the content stopped during play matches the switch marker content, i.e. if the playlist switching condition is fulfilled, the playlist switching determination unit 105 issues a switching request to the playlist switching controller 106, and the playlist switching controller 106 issues a switching instruction to the playlist switching unit 107. According to the switching instruction, the playlist switching unit 107 switches the playlists (step ST105). Upon completion of playlist switching, the playlist switching controller 106 instructs the playlist play unit 101 to start playing contents. The playlist play unit 101 thus starts playing the contents based on the newly assigned playlist (step ST106).

If the content stopped during play does not match the switch marker content, i.e. if the playlist switching condition is not fulfilled, the playlist switching determination unit 105 instructs the playlist play unit 101 to play the next content based on the current playlist (step ST704).

As described above, in a case that an error occurs during the play of a content, the system is controlled such that the play of the current content is interrupted, and the next content in the playlist is played or the current playlist is switched to a scheduled playlist for playing.

It should be noted that the content error detector 701 is also applicable to each of the digital content players shown in FIG. 3, FIG. 5, FIG. 7, FIG. 9, FIG. 11, FIG. 13 and FIG. 17.

### Eighth Embodiment

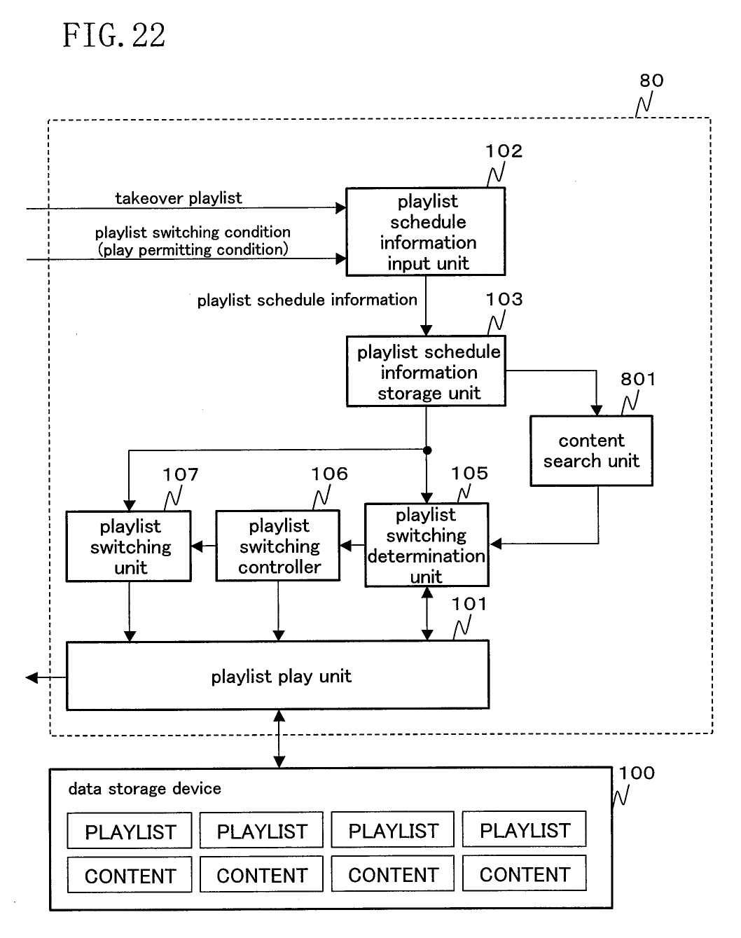

FIG. 22 shows the configuration of a digital content player according to the eighth embodiment of the present invention. The digital content player 80 includes a content search unit 801 instead of the content identification unit 104 of FIG. 1. In this embodiment, a condition which is to be met by a content played by the playlist play unit 101 (play permitting condition) is designated as the playlist switching condition. For example, a play permitting condition relating to category information may include a condition to exclusively play the contents categorized in sports out of movie contents, a condition to exclusively play the contents categorized in pops out of music contents, and the like. The play permitting condition is not limited to such category information but may be set in relation to artist information, date information, or the like.

The content search unit 801 searches the currently assigned playlist for any unplayed content that meets the play permitting condition indicated by the playlist schedule information stored in the playlist schedule information storage unit 103.

The playlist switching determination unit 105 receives a search result from the content search unit 801. The playlist switching determination unit 105 instructs the playlist play unit 101 to play a content found by the content search unit 801 subsequent to a content currently being played. If there is no unplayed content that meets the play permitting condition in the current playlist, i.e. if the content search unit 801 finds no unplayed content that meets the play permitting condition, the playlist switching determination unit 105 issues a switching request to the playlist switching controller 106.

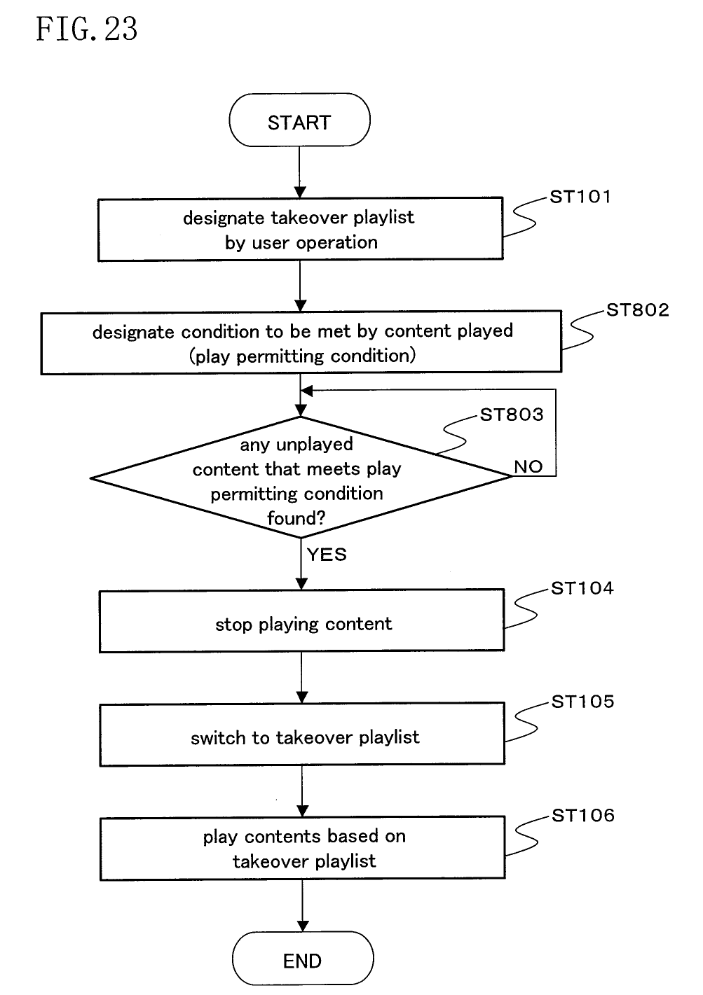

The playlist switching process in the digital content player 80 shown in FIG. 22 is now described with reference to FIG. 23.

First, the takeover playlist is designated by user operation (step ST101), and then, the play permitting condition is designated by user operation (step ST802). Playlist schedule information indicative of the takeover playlist and the play permitting condition is accordingly stored in the playlist schedule information storage unit 103. Step ST802 may be executed prior to step ST101.

Then, the content search unit 801 searches the current playlist for any unplayed content that meets the play permitting condition indicated by the playlist schedule information (step ST803). If no unplayed content that meets the play permitting condition is found, the playlist switching determination unit 105 issues a switching request to the playlist switching controller 106. According to the switching request, the playlist switching controller 106 stops the playlist play unit 101 from playing the content (step ST104). The playlist switching unit 107 then switches the playlists (step ST105). Upon completion of the playlist switching, the playlist switching controller 106 instructs the playlist play unit 101 to start playing contents (step ST106). The playlist play unit 101 thus starts playing the contents based on the newly assigned playlist.

As described above, the playlist can be switched after designating the playlist schedule information and playing contents which meet a specific condition.

Alternatively, the system may be controlled such that contents which meet the play permitting condition are played even after the playlist switching.

In the embodiments above, each of the playlist play unit 101, the playlist schedule information input unit 102, the content identification unit 104, the play content number counter 114, the play time manager 124, the playlist switching determination unit 105, the playlist switching controller 106, the playlist switching unit 107, the playlist switching notifier 201, the playlist schedule information manager 501, the display playlist generator 502, the playlist schedule information deletion unit 601, the content error detector 701, and the content search unit 801 can typically be realized by a MPU, memory, and the like. Each process procedure is typically realized by software, and such software is stored in a storage medium such as a ROM. Such software may be distributed in a form of, for example, software downloads and also may be stored in storage media, such as CD-ROMs, which are distributed to users. It should be noted that the process procedures may be realized by hardware (a special purpose circuit). The playlist schedule information storage unit 103 may typically be realized by a memory, or the like.

The display playlist generator 502 may be considered either to include a display device or not. The display playlist generator 502 may be realized by driver software of a display device, a combination of driver software of a display device and the display device, or the like.

The operation of the digital content player according to each embodiment may be interrupted by, for example, an interrupt of power-off or procedure exit.

The processes described in each embodiment may be realized by centralized processing using a single device or system, and also may be realized by distributed processing using a plurality of devices or systems. The programs may be executed by a single computer, and also may be by a plurality of computers. That is, either centralized processing or distributed processing is applicable.

It should be understood that the present invention is not limited to the particular embodiments described herein and is capable of various modifications, and therefore, all such modifications are covered within the scope of the present invention.

As described above, the digital content player according to the present invention has the effect of realizing scheduled play of playlist by switching the playlists at a predesignated timing using stored playlist schedule information, and is thus useful for, for example, devices that play movie, sound, music, and still picture files.

What is claimed is:

1. A digital content player for playing contents using a plurality of playlists, comprising:
a play unit for playing contents based on any one of the plurality of playlists which is assigned to the play unit;
a storage unit for storing playlist schedule information which is indicative of a takeover playlist and a playlist switching condition, the takeover playlist being a playlist scheduled to be newly assigned to the play unit, the playlist switching condition being a condition for playlist switching;
a monitoring unit for monitoring a state of the play of the contents in the play unit; and
a switching unit which determines whether the state of the play monitored by the monitoring unit fulfills the playlist switching condition indicated by the playlist schedule information and which switches, if the switching unit determines that the playlist switching condition is fulfilled, a playlist currently assigned to the play unit to the takeover playlist indicated by the playlist schedule information.

2. The digital content player according to claim 1, wherein
the playlist schedule information indicates, as the playlist switching condition, a content at which the current playlist is switched to the takeover playlist,
the monitoring unit identifies a content currently being played by the play unit, and
the switching unit detects completion of play of a content by the play unit while referring to an identification result from the monitoring unit and performs the playlist switching when detecting that play of the content indicated by the playlist schedule information is completed.

3. The digital content player according to claim 1, wherein
the playlist schedule information indicates, as the playlist switching condition, the number of contents to be played by the play unit during an interval between the storage of the playlist schedule information in the storage unit and the playlist switching,
the monitoring unit counts the number of contents played by the play unit since the storage of the playlist schedule information in the storage unit, and
the switching unit performs the playlist switching when detecting that the number of contents counted by the monitoring unit reaches the number of contents indicated by the playlist schedule information.

4. The digital content player according to claim 1, wherein
the playlist schedule information indicates, as the playlist switching condition, a play sustaining time between the storage of the playlist schedule information in the storage unit and the playlist switching,
the monitoring unit measures a time passed since the storage of the playlist schedule information in the storage unit, and
the switching unit performs the playlist switching when detecting that the passed time measured by the monitoring unit reaches the play sustaining time indicated by the playlist schedule information.

5. The digital content player according to claim 2, further comprising a notifier for notifying, when detecting that the content identified by the monitoring unit matches the content indicated by the playlist schedule information, about a schedule of performing the playlist switching at the end of the play of the content currently being played.

6. The digital content player according to claim 3, further comprising a notifier for notifying about the number of remaining contents before the playlist switching based on the number of contents to be played indicated by the playlist schedule information and the number of contents counted by the monitoring unit.

7. The digital content player according to claim 4, further comprising a notifier for notifying about a remaining time before the playlist switching based on the play sustaining time indicated by the playlist schedule information and the passed time measured by the monitoring unit.

8. The digital content player according to claim 1, wherein
the playlist schedule information indicates a content of the takeover playlist with which the play of the takeover playlist is to be started (play start content), and
the switching unit controls the play unit such that the play unit starts playing the takeover playlist with the play start content indicated by the playlist schedule information after the current playlist is switched to the takeover playlist.

9. The digital content player according to claim 1, wherein
the playlist schedule information indicates a content of the takeover playlist with which the play of the takeover playlist is to be ended (play end content), and
after the current playlist is switched to the takeover playlist, the switching unit stops the play unit from playing contents of the takeover playlist at the end of play of the play end content indicated by the playlist schedule information.

10. The digital content player according to claim 1, wherein
the playlist schedule information indicates an accompanying effect to be executed during play of a content based on the takeover playlist, and
the switching unit controls the play unit such that the accompanying effect indicated by the playlist schedule information is executed after the current playlist is switched to the takeover playlist.

11. The digital content player according to claim 1, further comprising a manager for managing a storage state of the playlist schedule information in the storage unit such that sets of the playlist schedule information are chained in the order of storage.

12. The digital content player according to claim 11, further comprising a list generator for generating a list of upcoming contents scheduled to be played based on the playlist schedule information stored in the storage unit.

13. The digital content player according to claim 11, further comprising a deletion unit for deleting a set of the playlist schedule information stored in the storage unit and rewriting a playlist switching condition indicated by another set of playlist schedule information chained to a trailing end of the deleted playlist schedule information set to a playlist switching condition of the deleted playlist schedule information set.

14. The digital content player according to claim 1, further comprising an error detector for detecting a play error in the play unit, wherein
the switching unit forcibly stops the play unit from playing a content when the error detector detects a play error and performs the playlist switching if the playlist switching condition is fulfilled and if otherwise instructs the play unit to play a next content.

15. A digital content player for playing contents using a plurality of playlists, comprising:
a play unit for playing contents based on any one of the plurality of playlists which is assigned to the play unit;
a storage unit for storing playlist schedule information which is indicative of a takeover playlist and a play permitting condition, the takeover playlist being a playlist scheduled to be newly assigned to the play unit, the play permitting condition being a condition which is to be met by a content played by the play unit;
a search unit for searching for a content which meets the play permitting condition indicated by the playlist schedule information from among contents scheduled to be played subsequent to a currently played content; and
a switching unit for switching a playlist currently assigned to the play unit to the takeover playlist indicated by the playlist schedule information if the search unit finds no content that meets the play permitting condition,
wherein the play unit plays a content detected by the search unit.

16. A semiconductor integrated circuit comprising the digital content player of claim 1.

17. A digital content playing method of playing contents using a plurality of playlists, comprising the steps of:
(a) playing contents based on any one of the plurality of playlists;
(b) storing in a storage medium playlist schedule information which is indicative of a takeover playlist and a playlist switching condition, the takeover playlist being a playlist scheduled to be newly assigned, the playlist switching condition being a condition for playlist switching;
(c) determining whether a state of the play of the contents in step (a) fulfills the playlist switching condition indicated by the playlist schedule information stored in the storage medium in step (b); and
(d) starting playing contents based on the takeover playlist indicated by the playlist schedule information if the playlist switching condition is determined to be fulfilled in step (c).

18. A digital content playing program which instructs a computer to execute the digital content playing method of claim 17.

19. A digital content playing method of playing contents using a plurality of playlists, comprising the steps of:
(a) selecting a second playlist as a subsequent play object during play of contents of a first playlist; and
(b) after the selection of the second playlist, switching the first playlist to the second playlist at the end of play of a currently played content of the first playlist.
